(19) United States
(12) Patent Application Publication
(10) Pub. No.: US 2006/0183091 A1
(43) Pub. Date: Aug. 17, 2006

(54) Method of training for grief support volunteers

(76) Inventor: Lawrence R. Fishel, Owings Mills, MD (US)

Correspondence Address: WHITEFORD, TAYLOR & PRESTON, LLP;ATTN: GREGORY M STONE, SEVEN SAINT PAUL STREET, BALTIMORE, MD, 21202-1626, US

(21) Appl. No.: 11/057,342

(22) Filed: Feb. 14, 2005

(51) Int. Cl. G09B 19/00

(52) U.S. Cl. 434/219

(57) ABSTRACT

A training method for peer-to-peer grief support volunteers is described that identifies common traits associated with the loss of a spouse, parent, sibling, or friend. The method addresses various theories of grief and unique attributes associated with the airline industry. The method further describes communication techniques and observations when working with survivors. The method also addresses self-protection methods for the volunteer. Training is specifically directed to non-professional, peer-to-peer grief support volunteers. Upon completion of the training, a certificate may be awarded to a trained participant.

### BACKGROUND OF THE INVENTION

1. Field of the Invention

This invention generally relates to a method of training for grief support volunteers, and more particularly, but not by way of limitation, to a method of training for grief support specifically directed to assisting members of the airline industry. Training is specifically directed to non-professional, peer-to-peer volunteers.

2. Background of the Art

Grief is defined as a deep mental anguish or sorrow over a loss. Such loss, in the extreme, may be caused by the death of a friend, family member, or co-worker. Sometimes the loss results from a sudden, traumatic event, such as an accident, natural disaster, or suicide. Not all deaths result from a sudden traumatic incident. When a person succumbs to a long-term illness, such as cancer, or dies of natural causes the survivors may be equally devastated by the loss.

Traumatic events are not easy for most people to understand or accept. The emotional impact of war and other trauma can have devastating effects on the mental well-being of individuals of all ages. Many people find it easier to focus energy on the needs of other people at times like these, often to the point of neglecting themselves.

The impact of a disaster or traumatic event goes far beyond the immediate devastation caused by the initial destruction. Just as it takes time to reconstruct damaged buildings, it takes time to grieve and rebuild lives. Life may not return to normal for months, or even years, following a disaster or traumatic event. There may be changes in living conditions that cause changes in day-to-day activities, leading to strains in relationships, changes in expectations, and shifts in responsibilities. These disruptions in relationships, roles, and routines can make life unfamiliar or unpredictable.

Many non-government organizations, such as the Red Cross offer training for responders to disasters and mass casualties. Typically, mental health care providers are trained to offer assistance to groups of people, usually adults, to help relieve stress associated with witnessing or involvement in such mass casualty. In most cases, the affected parties have an intact family or peer group to return to. On the other hand, grief counseling tends to be directed toward individuals or families, even children, who are affected by death or affected by their own impending death or the impending death of a loved one. For example, the death of a child can be emotionally devastating to a family. This is especially true when the death is unexpected, as in an accident, a suicide, or a sudden fatal illness. Peer-to-peer volunteer assistance can be critical in monitoring the family's understanding of the events and providing support in such a difficult moment.

The unique work environment and travel requirements associated with the airline industry present special needs for training volunteers to provide support in times of grief. Thus, there is a need for a method to train volunteers to recognize different types of grief or bereavement styles and situations.

Accordingly, there remains a need for a training method that goes beyond critical incident response to provide support for people suffering from grief that, in some cases, can last for a long time.

There remains a need for a training method that is not limited to specific time constraints or particular goals.

### SUMMARY OF THE INVENTION

It is, therefore, an object of the present invention to provide a training method for volunteer support personnel to provide peer-to-peer assistance for different causes of grief. A related object is to provide a training method for communication techniques for use by grief support volunteers.

It is another object of the present invention to provide a training method for volunteer support personnel to handle sudden onset grief and grief associated with chronic conditions.

While the present invention is directed to assisting members of the airline industry, the focus, content emphasis, and length of the training can vary according to its timing and function. Training is specifically directed to non-professional, peer-to-peer grief support volunteers.

Adult training is most effective when participants learn by seeing, doing, discussing, practicing, and receiving new information presented through multiple methods. In a preferred embodiment, the training described herein combines lecture presentations, reading, skills practice, self-awareness exploration, group discussion, and experiential learning.

In accordance with the above objects, a training method for peer grief support volunteers is described that identifies common traits associated with the loss of a spouse, parent, sibling, or friend. The method addresses various theories of grief with emphasis on unique attributes associated with the airline industry. The method further describes communication techniques and observations when working with survivors. The method also addresses self-protection methods for the support volunteer. Upon completion of the training, a certificate may be awarded to a trained participant.

### DETAILED DESCRIPTION OF THE INVENTION

The invention summarized above and defined by the enumerated claims may be better understood by referring to the following description. This description of an embodiment, set out below to enable one to practice an implementation of the invention, is not intended to limit the preferred embodiment, but to serve as a particular example thereof. Those skilled in the art should appreciate that they may readily use the conception and specific embodiments disclosed as a basis for modifying or designing other methods and systems for carrying out the same purposes of the present invention. Those skilled in the art should also realize that such equivalent systems do not depart from the spirit and scope of the invention in its broadest form.

In a preferred embodiment of the present invention, comprehensive training addresses:
Human reactions to traumatic loss;
Mental health interventions appropriate to various survivor groups;
Understanding human reactions to incidents of violence or suicide including traumatic bereavement and key events affecting the recovery process;
Learning methods for providing appropriate assistance to survivors and bereaved family members in private settings;
Learning considerations for intervening effectively with special populations including children and adolescents; and
Learning techniques to protect the support volunteer in order to maintain ability to provide effective assistance.

In order to understand the issue, the first step in the training is to identify characteristics of grief Grief occurs in response to the loss of someone or something. The loss may involve a loved one, a friend, or a co-worker. Anyone can experience grief and loss. It can be sudden or expected; however, individuals are unique in how they experience this event. Grief itself is a normal and natural response to loss. There is a variety of ways that individuals respond to loss. Some are healthy coping mechanisms and some may hinder the grieving process. It is important to realize that acknowledging the grief promotes the healing process. Time and support facilitate the grieving process, allowing an opportunity to appropriately mourn the loss.

Individuals experiencing grief from a loss may express such grief in a variety of ways. Generally, no two people will respond to the same loss in the same way. It is important to note that phases of grief exist; however, they do not depict a specific way to respond to loss. Rather, stages of grief reflect a variety of reactions that may surface as an individual makes sense of how this loss affects them. Experiencing and accepting all feelings remains an important part of the healing process.

According to several theories, there are many stages of normal grief:

Corer (1967)
1. Initial shock (first few days)—characterized by loss of self-control, reduced energy, lack of motivation, bewilderment, disorientation, and loss of perspective
2. Intense grief (several months)—characterized by periodic crying, confusion, and inability to understand what has actually happened
3. Gradual reawakening of interest—characterized by acceptance of reality of loved one's death and all it means

Stephenson (1985)
1. Reaction—period of initial shock when news of death is encountered; shock followed by numbness and a dazed lack of feeling, bewilderment, anger, and attempts to make sense out of loss
2. Disorganization and reorganization—reality sets in; bereaved person is disappointed that the loss cannot be recovered
3. Reorientation and recovery—bereaved person reorganizes the symbolic world and gives the deceased a new identity outside the world of the survivor

Click, Weiss, and Parkes (1974)
1. Initial response—characterized first by shock and then by an overwhelming sorrow
2. Coping with anxiety and fear—characterized by worry of nervous breakdown; some people depend on tranquilizers
3. Intermediate phase—consists of obsessional review of how the death might have been prevented and a reviewing of old memories of times with the deceased
4. Recovery (begins after 1 year)—person is proud that he or she has survived an extreme trauma and begins to develop a positive outlook

Bowlby (1960)
1. Concentration directed toward the deceased
2. Anger or hostility toward the deceased or others
3. Appeals to others for support and help
4. Despair, withdrawal, and general disorganization
5. Reorganization and direction of the self toward a new love object

Hardt (1978-79)
1. Denial (from time of death up to 1 month)
2. False acceptance (from 1-2 months)
3. Pseudoreorganization (from 2-3 months)
4. Depression (from 3-8 months)
5. Reorganizational acceptance (8 months and longer)

Kavanaugh (1974)
1. Shock—physical and emotional shock; real and unreal worlds collide
2. Disorganization—person feels totally out of touch with ordinary proceedings of life
3. Volatile emotions—mourner unleashes volatile emotions, upsetting those around him or her
4. Guilt—mourner feels guilty and depressed
5. Loss and loneliness—may be the most painful stage
6. Relief—may be difficult for mourner to acknowledge and openly adjust
7. Reestablishment—friends become important at this stage

Another step in the training process is to identify techniques to respond to individuals experiencing grief It has been found that volunteer assistance should also address the grief as it is manifested over time in stages that can be defined as a series of twos.

STAGE 1—From the Death Until Approximately 2 Weeks after the Death

The individuals/family are immobilized. They cannot think very well for themselves and they need assistance in many areas. The predominant amount of their thinking is about their loved one. Sleeping is difficult, eating is difficult, and it is not abnormal for numerous psychiatric symptoms to appear. The goal of a peer support volunteer in this stage is to work with a family representative to help (if asked) for assistance with services such as taking care of work difficulties or keeping unwanted collection or salespeople away. The predominant task is simply to listen and observe, and talk about the deceased.

STAGE 2—Between 2 Weeks and 2 Months

The survivors begin to feel “less bad”. That is an important term for peer support volunteers to use. “It will get better” is sometimes seen as disrespectful to the deceased. Their mind begins to focus on reforming their life. They do not always think about the deceased. Sleep becomes easier, and appetite begins to return. The peer support volunteers stay in “comfortable contact”. This could be a couple of times a week for support and encouragement. If the survivors require more contact, this would be a good time to call in a mental health professional.

STAGE 3—Between 2 Months and 2 Years

The new normal begins to be established. Functioning becomes more comfortable though the deceased continues to “pop” into the survivors thoughts. The peer support volunteers (if requested) should have contact about 1 to 2 times per month at the beginning of this stage, and phase contact out by the end of it.

STAGE 4—Two Years and On

At this point, a new normal has been established. The memory will always be present. In “chronic drawn out deaths” i.e. cancer, these stages can be accelerated.

The following is a list of guidelines for a peer support volunteer that may help resolve grief:
1) Allow time for the grieving individual to experience thoughts and feelings openly to self.
2) Acknowledge and accept all feelings, both positive and negative.
3) Use a journal to document the healing process.
4) Confide in a trusted individual; tell the story of the loss.
5) Encourage the grieving person to express feelings openly. Crying, although not required, may offer a release.
6) Identify any unfinished business and try to come to a resolution.
7) Bereavement groups provide an opportunity to share grief with others who have experienced similar loss.
8) If the healing process becomes too overwhelming, seek professional help.

Emotions, such as anxiety, fear, and depression, are not abnormal responses to grief. The two, two, and two technique can be used as part of a guide to ascertain if complicated grief is in evidence. Symptoms of complicated grief are:
1) Inability to move past the initial two-week mourning period, i.e., the individual has difficulty reentering the world;
2) Denial that the event has happened and denial of emotions, i.e., the person tries to act normally, such as returning to work the next day, acting in a hypo-manic fashion, or refusing to talk about the deceased;
3) Suicidal thoughts;
4) Hallucinations (still talking to the deceased immediately and long after their death); and
5) Refusal to accept the death.

The presence of certain symptoms that are not characteristic of a “normal” grief reaction may be helpful in differentiating bereavement from a Major Depressive Episode. These include 1) guilt about things other than actions taken or not taken by the survivor at the time of the death; 2) thoughts of death other than the survivor feeling that he or she would be better off dead or should have died with the deceased person; 3) morbid preoccupation with worthlessness; 4) marked psychomotor retardation; 5) prolonged and marked functional impairment; and 6) hallucinatory experiences other than thinking that he or she hears the voice of, or transiently sees the image of, the deceased person.

The death of a child can be emotionally devastating to a family. This is especially true when the death is unexpected, as in an accident, a suicide, or a sudden fatal illness. The loss is usually even more difficult to bear when the child has developed to the point at which he or she can interact socially with the parents. Then the parents may feel that they have failed to fulfill their parental obligations and hence directly or indirectly caused the death of the child. The accompanying feelings of guilt may interfere with the parents' ability to grieve properly and work through the loss of the child. Coupled with the guilt and depression experienced by bereaved parents are feelings of impotence, frustration, and anger that this should happen and at being unable to do anything for the fatally ill or dead child. The anger may be directed toward anyone who seems to bear a responsibility for the tragedy—the hospital staff, the parents themselves, and even God. These feelings are so intense in many cases that the parents never fully recover; the emotional problems associated with the death may still be present a decade or more after the death of the child. When one or both of the parents are unable to work through their grief, family life becomes disrupted. Some common traits parents feel after the death of their child include: impotence; anger; blame; guilt; shame; jealousy; incompleteness; substance abuse; and sexual dysfunction. Alcoholism, sleep and eating disturbances, and other symptoms of emotional disorder are commonplace, indicating a need for professional psychological counseling or psychotherapy. If untreated, these parental reactions often lead to separation and divorce.

Not only the parents but also all members of the family are affected by the fatal illness and death of a child. Grandparents grieve in a threefold sense—for the grandchild, for their son or daughter, and for themselves. Furthermore, the parents are frequently so preoccupied with their own thoughts and feelings and with attending to the dying or dead child that they neglect their other children.

The loss of a spouse or partner is devastating for a number of reasons: loss of consortium; loss of a best friend; loss of a maintenance partner; loss of other friendships; and loss of income. In some cases, the loss of a significant other may result in non-closure of unresolved differences as well as embarrassment, feeling of abandonment, anger, despair, and other physical symptoms.

Reactions to the death of siblings vary in relation as to how close the individuals were to the siblings. The siblings of dying and deceased children often feel anxious, deprived, confused, and socially isolated. The physical and behavioral changes that occur in a dying child as the illness progresses can also be frightening to a young brother or sister. In addition, when the child dies, the surviving children are not only sad, as everyone else in the family is, but they may also feel guilty for having mistreated the dead sibling or having wished he or she were dead. Some other reactions may include resentment for having to take over duties of the deceased sibling, the need to protect the sibling's survivors, emotionally and financially, and realization of their own aging process.

Training, according to the present invention, should include information concerning gender differences in mourning and bereavement behaviors. Generally, males tend to be internalizers who mourn covertly. They may internalize feelings of anger and exhibit searching and non-clinging type behaviors. Females generally tend to be externalizers who mourn overtly. They may externalize feelings of anger and exhibit nurturing and clinging type behaviors. The masculine style of grieving is characterized by reluctance to confront emotional tasks of grief; greater likelihood of tension and resistance to social support and professional support; a need to reject help of others as a show of strength; and a lesser expectation by others of need for social support. On the other hand, the conventional style of grieving is characterized by relative willingness and acceptance of need to experience emotional discomfort associated with loss; a dominant grief model and therapy approaches consistent with strengths of style; willingness to accept direct comfort and support from others as show of loss; and greater expectation by others of need for social support.

Some suggestions for helping masculine grievers include:
1) Provide the griever with basic human support and comfort;
2) Explore the individual's cognitive responses to the death;
3) Reassure the griever that crying and temporary loss of emotional control are normal responses to a loss;
4) Acknowledge all of the griever's affective expressions of grief, but do not insist they cry;
5) Respect the person's need to withdraw into self, or to a private place;
6) Encourage constructive venting of hostility, anger, and aggression;
7) Assist the griever, when appropriate, in recovering emotional self-control;
8) Focus the person's attention on identifying problems and solving them;
9) Facilitate a rapid return to useful and meaningful routines; and
10) Be alert to self-destructive behaviors, i.e. drugs/alcohol.

Mourning and bereavement behavior have unique attributes in the airline industry. In particular, pilots and other airline personnel tend to try to control their emotions. They will appreciate people's support, but tend to do the following:
1) Be private in their grief;
2) Try to keep busy after the death;
3) Be more inclined to experience anger and aggression than do others in the family;
4) In the case of children, they tend to feel the experience of loss, emptiness and a void;
5) Not as inclined to ask for compassion, support or affection (despite the fact that they need it);
6) Be less inclined to seek a professional's help;
7) “Try to return to normal function more quickly than others.” The widowed will tend to get support from their children less;
8) Tend to sweep reactions under the carpet as they deal with the funeral arrangements of the loved one;
9) In the case of the chronic condition, they will try to anticipate each and every step of the death of a loved one or their own death in order to not be “caught off guard;” and
10) There is a need to deny their feelings. This puts them in danger of suffering from posttraumatic stress/delayed.

In a preferred embodiment, training for the grief support volunteer should also include communication techniques. Communication techniques may vary according to the nature of the death. That is, was the death anticipated, such as due to natural causes, or sudden, such as by an accident? Was the death the result of a completed suicide or the result of violence, such as a homicide? Were there any special factors, such as fire, terrorist event, and the like?

Grievers are sensitive to some comments, such as “I'm sorry for your loss.” Early in the assistance process, physical contact should be minimized. It is appropriate to engage the griever in conversation about the deceased. Listen to stories, ask to see pictures, keep it comfortable. Care must be taken when communicating information to families using non-technical language and gearing to the family's vocabulary and level of sophistication. Volunteer support may take place over several sessions.

For instances of sudden onset grief, communication techniques may vary according to whether the event was publicized or unpublicized. In a publicized event, the survivor may be inundated by lots of media attention, which is generally unwanted, and many visitors arriving in droves. The survivors may receive instant unwanted notoriety, and the grieving process tends to be interrupted. In an unpublicized event, the survivor may receive no media attention, even though it may sometimes be wanted. Individual visitors may arrive in spurts. The event is usually quickly forgotten by the public, and the grieving process should occur normally.

A support volunteer should be aware of the impact of a traumatic event on the survivors. It is common for survivors to experience feelings of personal uncertainty, such as:
Feeling mentally drained and physically exhausted is normal and common.
The loss of companionship or income may result in a loss of self-esteem.
Unresolved emotional issues or pre-existing problems and previous losses may resurface.
Anniversaries of the traumatic event remind us of our losses. This reaction may be triggered by the event date each month and may be especially strong on the 1-year anniversary.

Furthermore, there are usually changes in the family relationship:
Relationships may become stressed when everyone's emotions are closer to the surface, and conflicts with spouses and other family members may increase.
Parents may be physically or emotionally unavailable to their children following a traumatic event, because they are preoccupied, distracted, or distressed by difficulties related to the event.
Parents may become overprotective of their children and their children's safety.
Children may be expected to take on more adult roles, such as watching siblings or helping with household efforts, leaving less time to spend with friends or participate in routine activities, such as summer camp or field trips.

Survivors may find disruptions in their work situation:
Fatigue and increased stress from preoccupation with personal issues can lead to poor work performance.
Conflicts with co-workers may increase, due to the added stress.
Reduced income may require taking a second job.

Regardless of individual circumstances, every survivor needs to complete several steps on the road to recovery from a traumatic event:
1) Accept the reality of the loss;
2) Allow yourself and other family members to feel sadness and grief over what has happened;
3) Adjust to a new environment—acknowledge that the person lost is gone forever;
4) Put closure to the situation and move on—do not continue to let the loss take its physical, emotional, or spiritual toll; and
5) Have faith in better times to come.

Encourage survivors to return to doing enjoyable things with friends and as a family; to reestablish the routines of life; and to make commitments and keep them.

Although communication is important, there are some factors that may hinder the healing process, such as avoidance or minimization of the survivor's emotions, use of alcohol or drugs to self-medicate, and use of work (overfunction at workplace) to avoid feelings.

Support volunteers should be trained to recognize signs of suicidality including risk factors and differences between adult suicides and adolescent suicides. Additionally, training for support volunteers should include techniques to provide support assistance to an individual that may be suicidal. In the event that a suicide has been completed, the grief support volunteer should be trained in strategies to assist survivors.

Support volunteers should also be trained to provide support assistance to individuals afflicted with chronic medical conditions, such as cancer, Alzheimer's disease, or AIDS. As with a crisis involving another person's death, a person informed of their own impending death may react in a series of stages.

Denial The first stage, denial, is a common reaction to being told that one is dying. Denial, of course, is an important self-protective mechanism. It enables people to keep from being overwhelmed or rendered helpless by the frightening and depressing events of life and to direct their attention to more rewarding experiences. Certainly, a seriously ill person will do well to question a terminal prognosis and seek additional medical opinions concerning the prognosis. However, denial becomes unrealistic when the patient invests precious time, money, and emotions in quacks and faith healers. These efforts are understandable, because it is difficult to face self-destruction; at an unconscious level, most people do not really believe they are going to die. By refusing to acknowledge the fact of death, people protect themselves from the anxiety generated by the realization that they will soon cease to exist. Denial of death manifests itself in many ways. For example, patients who have been told clearly and explicitly that they have a heart disorder, cancer, or some other serious illness sometimes deny having been told anything. Such “oversights” demonstrate how denial operates in selective attention, perception, and memory. Denial also has the effect of minimizing the importance of bad news and dogmatically refusing to believe it. Denial of death is not limited to dying patients. It is at least as common among medical personnel, who are trained to save lives and to whom the loss of a patient represents failure. The family and friends of dying persons also deny the inevitable, and all too often perform a disservice to patients in doing so.

Anger Continual deterioration of the patient's health and sense of well-being makes it more and more difficult to suppress the fact that time is getting short. As the dying process continues, denial gradually fades into partial acceptance of death. But partial acceptance creates feelings of anger at the unfairness of having to die without being given a chance to do all that one wants to do, especially when so many less significant or less valuable people will continue to live. The feelings of anger experienced by the dying person are frequently non-discriminating being directed at family, friends, the hospital staff, and God. The direct target of the patient's anger, however, is the unfairness of death rather than other people. It is important for those who have regular contacts with dying people to be prepared for these attacks of anger and to recognize that much of the hostility represents defensive displacement.

Bargaining In the normal course of events, the patient's anger fades and is replaced by desperate attempts to buy time, for example, by striking a bargain with fate, God, the attending physicians, or with anyone or anything that offers hope for recovery or at least a delay in the time of death. Although it is not obvious in all patients, the stage of bargaining represents a healthier, more controlled approach than denial and anger. In any event, patients in this stage make many promises—to take their medicine without fussing, to attend church regularly, to be kinder to other people, and so on. Praying for forgiveness, embracing new religious beliefs, and engaging in rituals or magical acts to ward off death are also common.

Depression The fourth stage is depression, a stage in which the partial acceptance of the second stage gives way to a fuller realization of impending death. Denial, anger, and bargaining have all failed to stave off the demon, so the patient becomes dejected in the face of everything that has been suffered and will be relinquished in dying. Like the previous three stages, depression is a normal and necessary step toward the final peace that comes with complete acceptance. loved ones and medical personnel should let the patient feel depressed for a while, to share the patient's sadness, and then to offer reassurance and cheer when appropriate.

Acceptance The last stage of dying, that of acceptance, is characterized by “quiet expectation” and as being the healthiest way of facing death. The weakened, tired patient now fully accepts death's inevitability, and its blessings in terms of release from pain and anxiety. The patient may reminisce about life, finally coming to terms with it and acknowledging that the experience has been meaningful and valuable. This is a time of disengagement from everyone except a few family members and friends and the hospital staff. In these social interactions, old hurts become erased and last goodbyes are said.

Another step in the training method is to teach grief support volunteers how to protect themselves during and after emotionally difficult support sessions. Volunteers should be encouraged to explore their own feelings about a death that could impede present interventions. They should face their own anxiety about losses and their own fears for their own children's health and safety. Furthermore, they should explore their own history of losses and write down what they have learned to do and what not to do.

It is important that support volunteers operate within their own limitations of the type of grief work that they can handle. Support volunteers should rotate visits during the initial two weeks and over time as frequently as comfortable for the deceased's family. When not involved in the situation, support volunteers should get away from it, in order to refuel themselves.

A volunteer who has successfully completed a grief support volunteer training regimen should be recognized with an appropriate certificate of completion.

The invention has been described with references to a preferred embodiment. While specific values, relationships, materials and steps have been set forth for purposes of describing concepts of the invention, it will be appreciated by persons skilled in the art that numerous variations and/or modifications may be made to the invention as shown in the specific embodiments without departing from the spirit or scope of the basic concepts and operating principles of the invention as broadly described. It should be recognized that, in the light of the above teachings, those skilled in the art can modify those specifics without departing from the invention taught herein. Having now fully set forth the preferred embodiments and certain modifications of the concept underlying the present invention, various other embodiments as well as certain variations and modifications of the embodiments herein shown and described will obviously occur to those skilled in the art upon becoming familiar with such underlying concept. It is intended to include all such modifications, alternatives and other embodiments insofar as they come within the scope of the appended claims or equivalents thereof. It should be understood, therefore, that the invention may be practiced otherwise than as specifically set forth herein. Consequently, the present embodiments are to be considered in all respects as illustrative and not restrictive.

What is claimed is:

1. A method of training for grief support volunteers, said method comprising:
identifying to a grief support volunteer characteristics of grief;
identifying techniques to said support volunteer in order to respond to individuals experiencing grief;
teaching techniques to said support volunteer for communication with grievers;
teaching techniques for emotionally protecting said support volunteer during and after a support session; and
awarding a certificate of completion to a support volunteer that has successfully completed the training method.

2. The method of training according to claim 1, wherein
the technique in order to respond to individuals experiencing grief is a four stage technique defined as a series of twos.

3. The method of training according to claim 2, wherein the first stage extends from the death until approximately 2 weeks after the death.

4. The method of training according to claim 2, wherein the second stage extends from 2 weeks after the death until approximately 2 months after the death.

5. The method of training according to claim 2, wherein the third stage extends from approximately 2 months after the death until approximately 2 years after the death.

6. The method of training according to claim 2, wherein the fourth stage extends beyond approximately 2 years after the death.

7. The method of training according to claim 1, wherein
the technique in order to respond to individuals experiencing grief includes information concerning gender differences in mourning and bereavement behaviors.

8. The method of training according to claim 1, wherein
the technique in order to respond to individuals experiencing grief includes information concerning unique mourning and bereavement behaviors associated with the airline industry.

9. The method of training according to claim 1, further comprising:
identifying techniques to distinguish between support needs for publicized sudden onset grief and support needs for non-publicized sudden onset grief.

10. The method of training according to claim 1, further comprising:
teaching said support volunteer to recognize signs of suicidality.

11. The method of training according to claim 10, further comprising:
teaching said support volunteer to identify risk factors and differences between adult suicides and adolescent suicides.

12. The method of training according to claim 1, further comprising:
teaching said support volunteer techniques to provide support to an individual that may be suicidal.

13. The method of training according to claim 1, further comprising:
teaching said support volunteer techniques to provide support to an individual afflicted with a chronic medical condition.
